(19) United States
(12) Patent Application Publication
(10) Pub. No.: US 2004/0148298 A1
(43) Pub. Date: Jul. 29, 2004

(54) Browse information management system and management method

(76) Inventor: Takeshi Terasawa, Takasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/722,501

(22) Filed: Nov. 28, 2003

(30) Foreign Application Priority Data
Nov. 29, 2002 (JP) 2002-347079

(51) Int. Cl. G06F 17/00

(52) U.S. Cl. 707/100

(57) ABSTRACT

To provide a browse information management system capable of flexibly controlling concealment areas of confidential portions in accordance with a user's browse authority level with respect to browse information including character strings, images, animations, or the like without time and labor required for maintenance such as response to new users. In the browse information management system comprising a mask layer data selecting means and a mask layer data combining means, the selecting means selects a single or plurality of pieces of mask layer data, in accordance with a user's browse authority level, from among a plurality of pieces of mask layer data in which concealment areas are drawn. The combining means combines the single or plurality of pieces of mask layer data selected by the selecting means with respect to original data that is browse information. Then, the user is provided by performing a concealing process to the browse information.

### BACKGROUND OF THE INVENTION

The present invention relates to a system for managing confidential items and the like with respect to browse information including electronic documents, images, and animations and, particularly, to a technique effective as a management system and a management method capable of corresponding to a plurality of browse authority levels and performing an appropriate concealing process for the browse information in accordance with the respective levels.

According to examinations by the present inventors, the following has been considered as to a concealing processing technique for browse information and to a management technique related to the concealing processing.

For example, in an electronic filing device for recognizing an index from a document image to automatically register a large amount of text, there is a concealing processing technique for performing image display in which confidential items are concealed. This processing method, first, uses format information previously created at the time of document registration to analyze a document structure, and extracts descriptive areas of the confidential items to store a coordinate value thereof in a large-capacity memory together with the image data. Then, an image mask pattern is generated from the coordinate value at the time of the image display, and a logical operation between this mask pattern and the image data is performed and is then output to a display or the like (for example, see Patent Document 1).

Further, there is also a document management technique for selectively extracting a plurality of pieces of output information depending on a plurality of browse authority levels from the same file original. In other words, it can be a technique for concealing unselected portions. This document management means inserts, into the file original, tag information for defining a range of the output information, and gets this tag information to correspond to a browse authority level, and extracts and displays a document specified by the tag information (for example, see Patent Document 2).

Further, there is also a technique for applying a concealing process to character strings to be confidential items with respect to browse information such as messages of electronic mails, text-form files, and the like. This concealing processing method is a method of: extracting the character strings in the browse information on the basis of a database where proper names or an extraction rule is accumulated; integrating the extracted character strings in accordance with a database where an integration rule is accumulated; and then replacing them with mask characters such as asterisk or the like (for example, see Patent Document 3).

Furthermore, there is also a technique for completely concealing specific portions of browse information using original data and mask data. This technique is a technique of first manually creating mask data, which is image data indicating a concealment area, with respect to the original data that is a format in which character data and image data are present in a mixed manner. Then, the original data and the mask data are captured to generate intermediate data that is a format with only the image data and, further, a format conversion is performed for the intermediate data to return it to the format in which the character data and the image data are present in a mixed manner (for example, see Patent Document 4).

[Patent Document 1]

Japanese Patent Laid-open No. 6-290251 (abstract of page 1, and the like)

[Patent Document 2]

Japanese Patent Laid-open No. 2000-235569 (abstract of page 1, and the like)

[Patent Document 3]

Japanese Patent Laid-open No. 2002-149638 (abstract of page 1, and the like)

[Patent Document 4]

Japanese Patent Laid-open No. 2002-207725 (abstract of page 1, and the like)

### SUMMARY OF THE INVENTION

As a result of the examinations by the present inventors, regarding the concealing processing technique for the browse information and the management technique relating to the concealing process as described above, the following has been made clear.

The concealing technique and the management technique relating to the concealing process have been increasingly required in the case where, for example, an outsider browses browse information as the trends of electronic management of various documents and information disclosure are realized. As technical requirement matters in such a case, there is recited the fact that: (1) only confidential information portions in a document including an image are not displayed; (2) information to be browsed can be controlled for each group to which a user belongs, that is, a concealing process can be variably applied in accordance with a browse authority level; (3) responses to a new confidential portion, a new document, a publication date, and a new user group, that is, security maintenance does not require time and labor; (4) original browse information is not processed in order to guarantee the originality thereof; and the like.

For example, the techniques as disclosed in the Patent Documents 1 to 4 have the following problems with respect to the above requirement matters.

At first, the technique according to the Patent Document 1 is a technique for uniquely applying a concealing process to a large amount of documents based on an analyzing process in a document structure, and does not particularly assume a case where the concealing process is variably applied in accordance with a browse authority level. Further, when the relevant technique is used in the case, such technique is considered to be unsuitable since it is expected that the analyzing process in the document structure is made complicated.

Next, the technique according to the Patent Document 2 is a technique suitable for a case where the concealing process is variably applied in accordance with a browse authority level, but requires to certainly change original browse information to a tag-form file in responding to a new document. Further, correction of the tag information is sequentially required in responding to a new document and a new user group, so that the maintenance thereof requires time and labor.

Further, the technique according to the Patent Document 3 is a technique for using, as a target, documents without an image and uniquely applying the concealing process from a document structure similarly to the technique according to the Patent Document, and does not assume a case where the concealing process is variably applied in accordance with the browse authority level. Therefore, this technique is considered to be unsuitable for this case.

Then, the technique according to the Patent Document 4 is a technique for performing the concealing process by overlapping, on the original data, a mask data image for manual setting. In the embodiment in the relevant Document, there is shown an example, in which a plurality of files combing original data and mask data are created and the created files are used based on a user's browse authority level. However, a method of using the files based on the browse authority level is not particularly specified, and the management system based on the browse authority level is not originally a technique as the gist of the embodiment. If the technique is applied as the management system, managing a large number of files is required and the maintenance thereof requires time and labor.

Thus, an object of the present invention is to provide a browse information management system and a management method capable of flexibly controlling concealment areas in confidential portions in accordance with a user's browse authority level without requiring time and labor for security maintenance with respect to browse information including character strings, images, animations, or the like.

Further, another object of the present invention is to provide a browse information management system and a management method requiring no time and labor for security maintenance even when a large number of users and a large amount of browsed information are present.

The above and other objects and novel features will become apparent from the description of the present specification and the accompanying drawings.

Outlines of representative ones among the inventions, disclosed in the present application, will be briefly described as follows.

A browse information management system according to the present invention is a system for combining, with respect to original data that is browse information and in accordance with a user's browse authority level, mask layer data in which a graphic covering a confidential portion is drawn, and for getting a user to browse it.

Thus, the browse information management system according to the present invention is a system using a computer, and is a system including: a selecting means for selecting a single or plurality of pieces of mask layer data from among a plurality of pieces of mask layer data in accordance with a browse authority level of a user; and a combining means for combining, with respect to original data, the single or plurality of pieces of mask layer data selected by said selecting means.

Further, the browse information management system according to the present invention is a system responding even when the piece number of original data is two or more, and having a browse possibility/impossibility determining means for determining a browse possibility/impossibility of each of a plurality of pieces of original data in accordance with the browse authority level of a user, and for getting said user to specify the original data through communication with said user.

Additionally, said browse possibility/impossibility determining means and said mask layer data selecting means each refer to a browse authority master, and said browse authority master has identification information of a user, browse possibility/impossibility information of original data by said user, and mask layer data selecting information of original data browsable by said user.

Further, said browse authority master is divided into a user authority master and a mask layer master to be managed.

First, said user authority master has a data structure capable of, in accordance with identification information of a user, specifying a browse authority level of said user and original data browsable by said user.

Then, said mask layer master has a data structure capable of specifying, in accordance with a browse authority level and original data specified with reference to said user authority master, a single or plurality of pieces of mask layer data to be combined with said original data.

Further, the browse information management system according to the present invention comprises: a browse information library; a mask layer library; and a mask layer combining section, wherein a large amount of original data is stored in said browse information library and a large amount of mask layer data is stored in said mask layer library.

In the above-mentioned browse information management system, said browse possibility/impossibility determining means firstly specifies, in response to a browse request from a user, a browse authority level of said user with reference to said user authority master, and specifies original data through communication with said user to extract said specified original data from said browse information library.

Next, said mask layer data selecting means specifies a single or plurality of pieces of mask layer data, with reference said the mask layer master in accordance with said original data specified by said determining means and a browse authority level, to extract said specified single or plurality of pieces of specified mask layer data from said mask layer library.

Additionally, said mask layer data combining means transmits, to said mask layer combining section, the original data extracted by said determining means and the single or plurality of pieces of mask layer data extracted by said selecting means so as to be combined in said mask layer combining section.

Further, a browse information management system according to the present invention is system corresponding to a client-server type network system. A server system has a browse information management system as described above, and a client terminal has a browser so that a user makes a browse request of browse information to said server system and acquires browse information through said server system in accordance with a browse authority level of said user.

Further, a browse information management system of said client-server type has, as server systems, a first server system and a second server system connected to each other via a network.

Additionally, said server system has: said browse authority master in said first server system; and said mask layer library, said browse information library, and said mask layer combining section in said second server system. Alternatively, it has: said browse authority master and said mask layer library in said first server system; and said browse information library and said mask layer combining section in said second server system.

Further, in a browse information management method, which uses a computer, according to the present invention, the computer includes original data as browse information, and a plurality of pieces of mask layer data in each of which a graphic covering a confidential portion is drawn in accordance with a browse authority level. When browse of said browse information is requested from a user, a single or plurality of pieces of mask layer data are firstly selected from among said plurality of pieces of mask layer data in accordance with the browse authority level of said user. Then, said selected single or plurality of pieces of mask layer data is combined with respect to said original data. Further, said combined data is outputted to said user.

Further, when said single or plurality of pieces of mask layer data are selected, a browse possibility/impossibility of said original data by said user is determined with reference to a browse authority master, and said single or plurality of pieces of mask layer data are selected in accordance with the browsable original data.

### BRIEF DESCRIPTION OF THE DRAWINGS

FIG. 1 is an explanatory diagram showing one example of a concealing processing operation technique according to the present invention.

FIG. 2 is a block diagram showing a structure example of a browse information management system that is an embodiment of the present invention.

FIG. 3 is a block diagram showing a structure example of a browse authority master in a browse information management system that is an embodiment of the present invention.

FIG. 4 is a management flow diagram showing one example of a management method in a browse information management system that is an embodiment of the present invention.

FIG. 5 is a block diagram showing a structure example of a browse information management system that is a modified example of an embodiment of the present invention.

FIG. 6 is a block diagram showing another structure example of a browse information management system that is a modified example of an embodiment of the present invention.

FIG. 7 is a block diagram showing still another structure example of a browse information management system that is a modified example of an embodiment of the present invention.

### DETAILED DESCRIPTION OF THE PREFERRED EMBODIMENT

Embodiments of the present invention will be below described in detail with reference to the drawings. Note that through all the drawings for describing the embodiments, the same members are denoted by the same reference symbol and the repetition thereof will not be omitted.

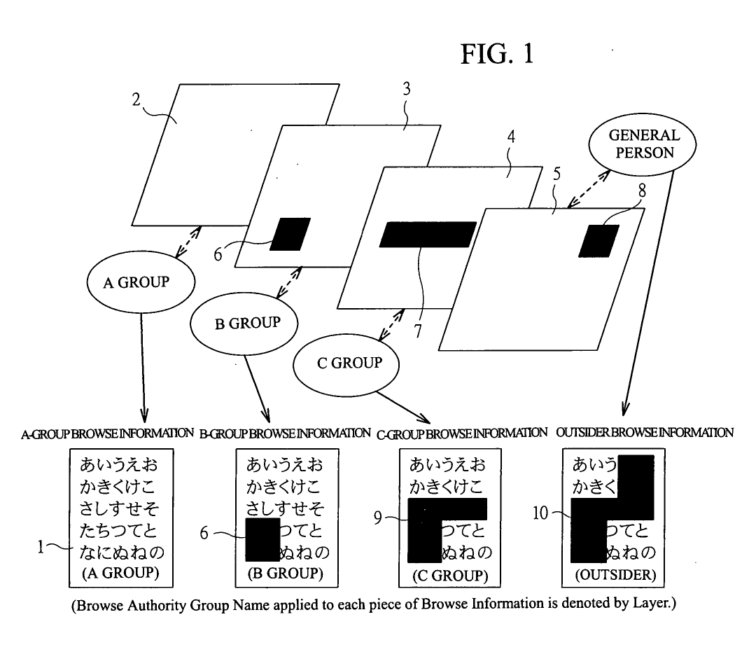

FIG. 1 is an explanatory diagram showing one example of a concealing processing operation technique that is a basic concept of the present invention.

First, with reference to FIG. 1, one example of the concealing processing operation technique, which is a basic concept of the present invention, is described.

In the concealing processing operation technique, there are provided, for example, original data 1 and mask layer data 2, 3, 4, and 5, and a browse authority level is classified in: a user in A group; a user in B group; a user in C group; an outside user; and the like.

Next, in the concealing processing operation technique in FIG. 1, there is described one example of the case where the user in A group, the user in B group, the user in C group, and the outside user request the browsing of the original data 1.

This concealing processing operation is performed in accordance with program control by a computer.

The user in A group is given an authority to browse the original data without concealment. Therefore, the A-group user can browse the original data as it is, or browse the browse information in which the mask layer data 2, on which nothing is described, is combined with respect to the original data. However, it is considered that the latter is easier browsed from the viewpoint of management.

The user in B group is given an authority to browse items other than the items described in a concealment area 6 with respect to the original data 1. Thus, the mask layer data 3, in which a concealment area 6 is filled with black, is previously prepared, and the original data 1 and the mask layer data 3 are combined when a browse request from the B-group user is made. By doing so, the B-group user can browse the browse information in which the concealment area 6 is concealed with respect to the original data 1.

The user in C group is given an authority to browse items other than the items described in a concealment area 9 further adding a concealment area 7 to the concealment area 6 with respect to the original data 1. Thus, a mask layer data 4, in which the concealment area 7 is filled with black, is previously prepared, and the original data 1, the mask layer data 3, and the mask layer data 4 are combined when a browse request from the C-group user is made. By doing so, the C-group user can browse the browse information in which the concealment area 9 is concealed with respect to the original data 1. Alternatively, the concealment area 9 in the mask layer data 4 may be filled with black to combine the original data 1 and the mask layer data 4.

A general person (outside user) is given an authority to browse items other than the items described in a concealment area 10 further adding a concealment area 8 to the concealment areas 6 and 7 with respect to the original data 1. Also in this case, similarly to the case of the C-group user, by combining the mask layer data 3, 4, and 5 with respect to the original data 1 or combining therewith the mask layer data 5 in which the concealment area 10 is filled with black, the outside user can browse the browse information in which the concealment area 10 is concealed.

Whether a plurality of pieces of mask layer data are combined or whether single mask layer data is combined depends on complexity of a relationship between the browse authority level and the concealment area. However, for example, since the mask layer data 3, 4, and 5 can be used to deal with six kinds of concealment areas, it is better that a plurality of pieces of mask layer data are combined in order to reduce the number of pieces of mask layer data.

Since the mask layer data is image data capable of freely drawing graphics, the concealing process can be performed even when the original data 1 is an image, an animation, and the like in addition to a document. Further, if only mask layer data is newly created or a combination of existing mask layer data is changed, security maintenance such as responses to a new confidential portion, a new document, and a new user group is easy to carry out. Further, since the original data 1 does not need to be processed at all, there is advantageous in that the originality is guaranteed.

Therefore, according to the concealing processing operation technique based on the above-mentioned browse authority level, flexible control of the concealment areas can be performed to the browse information, which includes a document, an image, an animation, and the like, in accordance with the user's browse authority level, and additionally the original data does not need to be processed at all and the security maintenance also can be easily achieved.

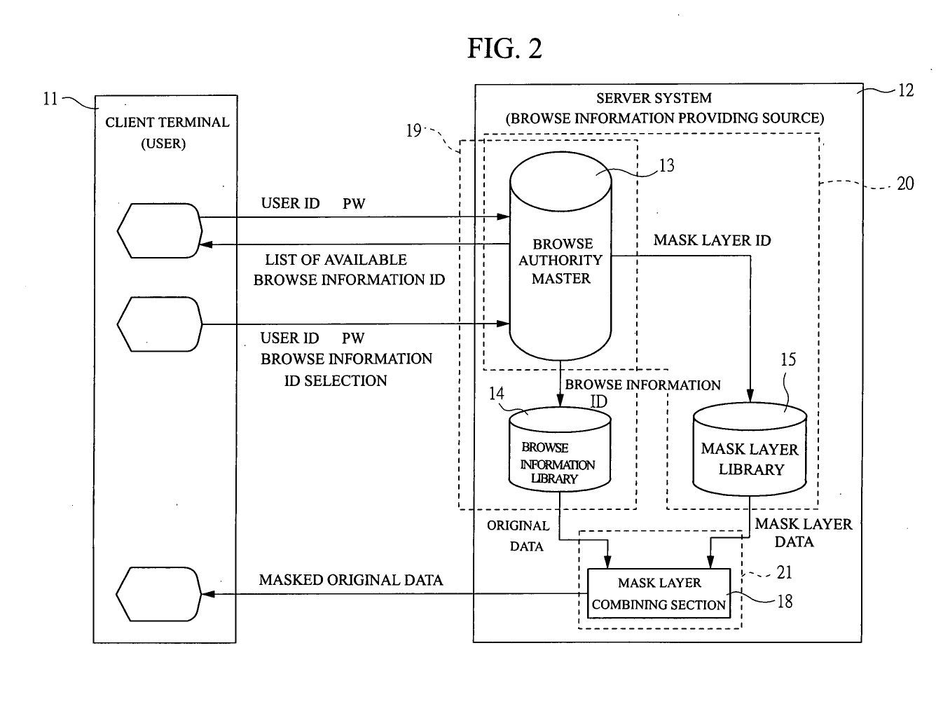

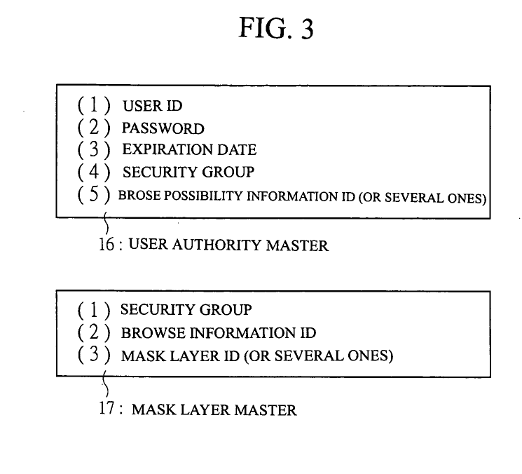

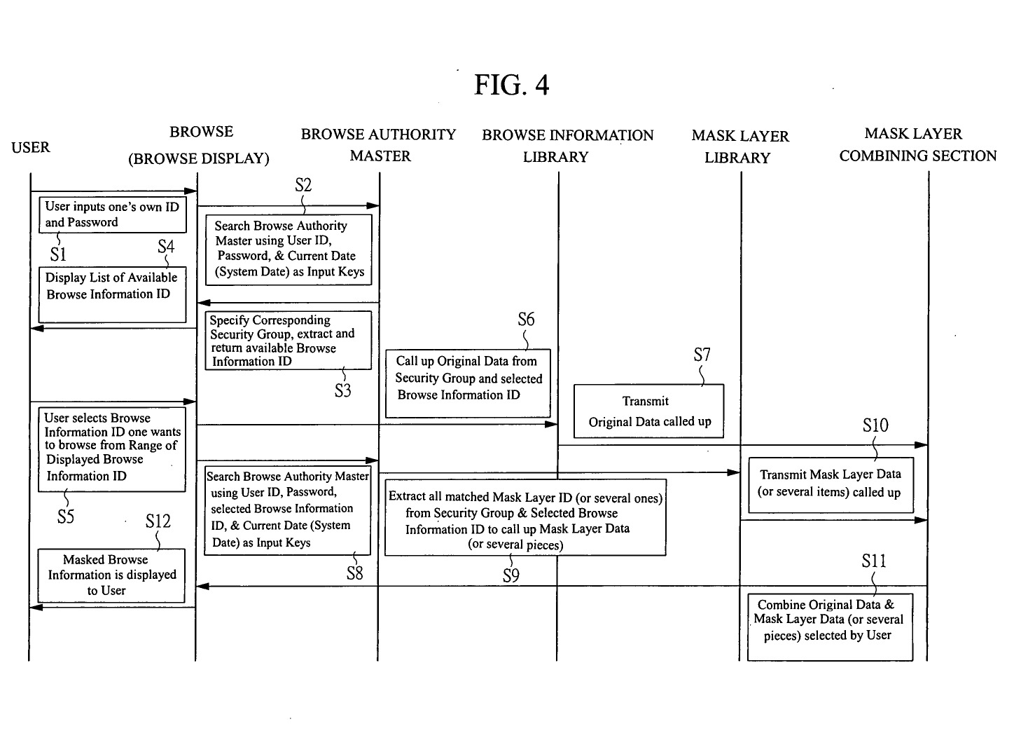

FIG. 2 is a block diagram showing one example of a browse information management system that is an embodiment of the present invention, FIG. 3 is a bloke diagram showing one example of a browse authority master in the browse information management system, and FIG. 4 is a management flow diagram showing one example of a management method of browse information. The present embodiment is one example where the browse information management system is constructed using the concealing processing operation.

At first, one example of a structure of the browse information management system according to the present embodiment will be described with reference to FIGS. 2 and 3.

The browse information management system in FIG. 2 is a client-server type network system, and comprises a client terminal 11 operated by a user, and a server system 12 for providing browse information.

The client terminal 11 mounts a browser thereon, thereby allowing inputting/outputting data into/from the server system 12. The server system 12 includes: a browse authority master 13 that is a database; a browse information library 14; a mask layer library 15; and a mask layer combining section 18.

The browse authority master 13 comprises a user authority master 16 and a mask layer master 17. As shown in FIG. 3, the user authority master 16 has: user identification information including (1) a user ID, (2) a password, and (3) an expiration date; (4) a security group that is information on a browse authority level to which a user belongs; (5) a browsable information ID that is browse possibility/impossibility information of the original data by a user; and the like. Further, as shown in FIG. 3, the mask layer master 17 has: (1) a security group that is information on a browse authority level to which a user belongs; (2) a browse information ID that is identification information of a title of the original data; (3) a mask layer ID that is selection information of mask layer data to be combined with the original data; and the like.

The browse information library 14 stores a large amount of data corresponding to the original data 1 and the like shown in FIG. 1, which is one example of the concealing processing operation technique, and the mask layer library 15 stores a large amount of data corresponding to the mask layer data 2 to 5 and the like shown in FIG. 1.

Next, one example of the management flow in the browse information management system according to the present embodiment will be described using FIG. 4 with reference to FIGS. 2 and 3.

This management flow is performed in accordance with a program of controlling the system.

In S1, a user uses a browser from the client terminal 11 in FIG. 2 to input a user ID and a password.

In S2, the browser searches the browse authority master 13 in the server system 12 in FIG. 2, by regarding, as input keys, the user ID, the password, and a current date owned by the client terminal 10.

In S3, in the server system 12, a security group of the user and a title list of the original data browsable by the user are specified by the user authority master 16 in FIG. 3, and a list of the browse information ID indicating the title of the browsable original data is returned to the client terminal 11.

In S4, the list of the browse information ID browsable by the user is displayed on the browser in the client terminal 11.

In S5, the user selects the browse information ID for requesting a browse from the list of the browse information ID on the browser.

In S6, the browser transmits the selected browse information ID to the server system 12, and the server system 12 extracts the original data corresponding to the browse information ID, from the browse information library 14 in FIG. 2.

In S7, the extracted original data is transmitted to the mask layer combining section 18 in FIG. 2.

In S8, the browser searches the mask layer master 17 in FIG. 3 by regarding, as input keys, the user ID and the password inputted by the user, the current date that the client terminal 11 owns, and the selected browse information ID or by regarding, as input keys, the security group determined by the search of the user authority master, and the selected browse information ID.

In S9, through the mask layer ID determined by the search, the server system 12 extracts a single or a plurality of pieces of mask layer data matched therewith, from the mask layer library 15 in FIG. 2.

In S10, the single or plurality of pieces of extracted mask layer data are transmitted to the mask layer combining section 18.

In S11, the server system 12 combines the extracted original data and the single or plurality of pieces of extracted mask layer data in the mask layer combining section 18, and returns the combination to the client terminal 11.

In S12, the user can browse the combined data on the browser of the client terminal 11.

In the above management flow, S1 to S6 correspond to a processing part performed by a browse possibility/impossibility determining means 19, in the control function by the program; S8 and S9 correspond to a processing part performed by a mask layer data selecting means 20; and S7, S10, and S11 correspond to a processing part performed by a mask layer data combining means 21.

As seen from the above management flow, the security maintenance such as responses to a new confidential portion, a new document, a publication date, and a new user group is easy to carry out since there is at most required only the works of: registering the original data in the browse information library 14; creating the mask layer data capable of easily being created; registering it in the mask layer library 15; and registering information in the browse authority master 13.

Further, the browse authority master 13 is separated into the user authority master 16 and the mask layer master 17 to be managed so that it is possible to easily grasp whether or not the user can browse the original data when a large amount of original data is present, and which mask layer data is combined if the user can browse. Therefore, this is advantageous for the security maintenance. Furthermore, since the browse authority master 13, the browse information library 14, and the mask layer library 15 are three kinds of respective separated databases, the security maintenance can be easily achieved, thereby allowing a browse information management system optimum for an in-company network or the like to be constructed.

Therefore, according to the browse information management system that is the present embodiment, the concealing processing operation in accordance with the browse authority level shown in the basic concept of the present invention can be used to construct the browse information management system corresponding to a large number of users, a large amount of original data, and a large amount of mask layer data. Further, the security maintenance can be also achieved easily, thereby allowing the browse information management system optimum for, particularly, an in-company network or the like to be constructed.

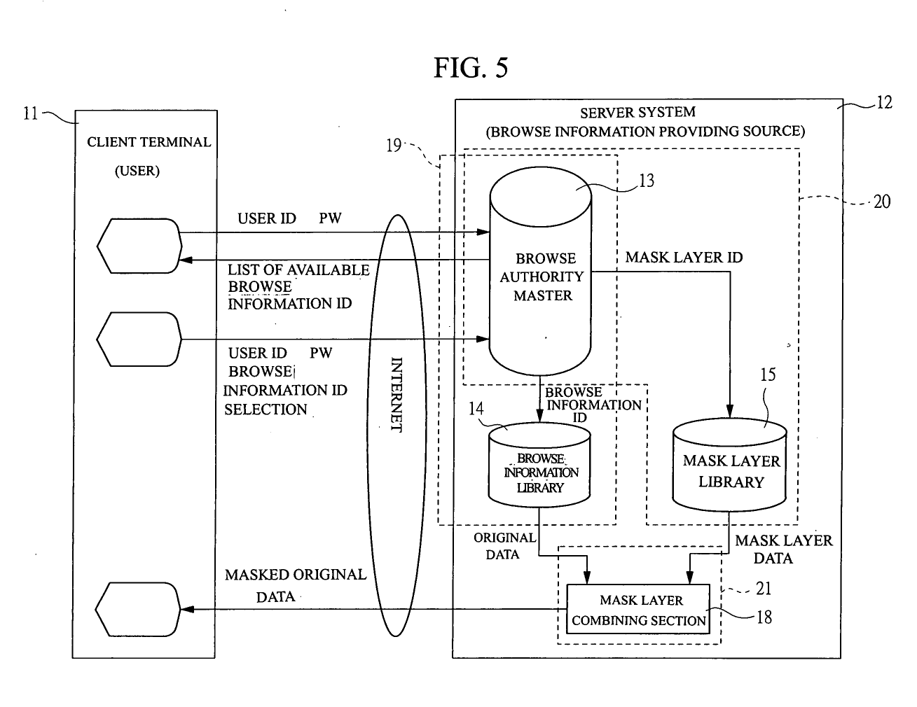

FIGS. 5, 6, and 7 show structure examples of a browse information management system that is a modified example of the embodiment of the present invention. The browse information management system, which is the modified example of the present embodiment, is an example where the structure of the browse information management system according to the previous embodiment is modified in view of utilization in a large scale network including the intranet, the Internet, and the like in a company. Since a management flow of the browse information management system, which is the modified example of the present embodiment, is the same as that of the browse information management system of the present embodiment, a description of the management flow will be omitted and structures and advantages thereof in FIGS. 5, 6, and 7 will be described.

At first, the browse information management system in FIG. 5 is an example where the client terminal 11 and the server system 12 are connected over the Internet. A large number of client terminals 11 are present, although not clearly shown in FIG. 5, and are connected to the server system 12 via each Internet.

Over the Internet, there are browsed a large number of: electronic document files such as PDF or the like; various kinds of image data files such as bitmap images, JPEG images, or the like; animation data files; and the like. Conventionally, it was possible to disable to browse those files themselves through the management of the browse authority level, but it was difficult to perform concealing control for partial areas of those files in accordance with the browse authority level. When the browse information management system shown in FIG. 5 is used, the above problem can be solved since the user can browse the mask layer data combined with the image data file or the like in accordance with the user's browse authority level.

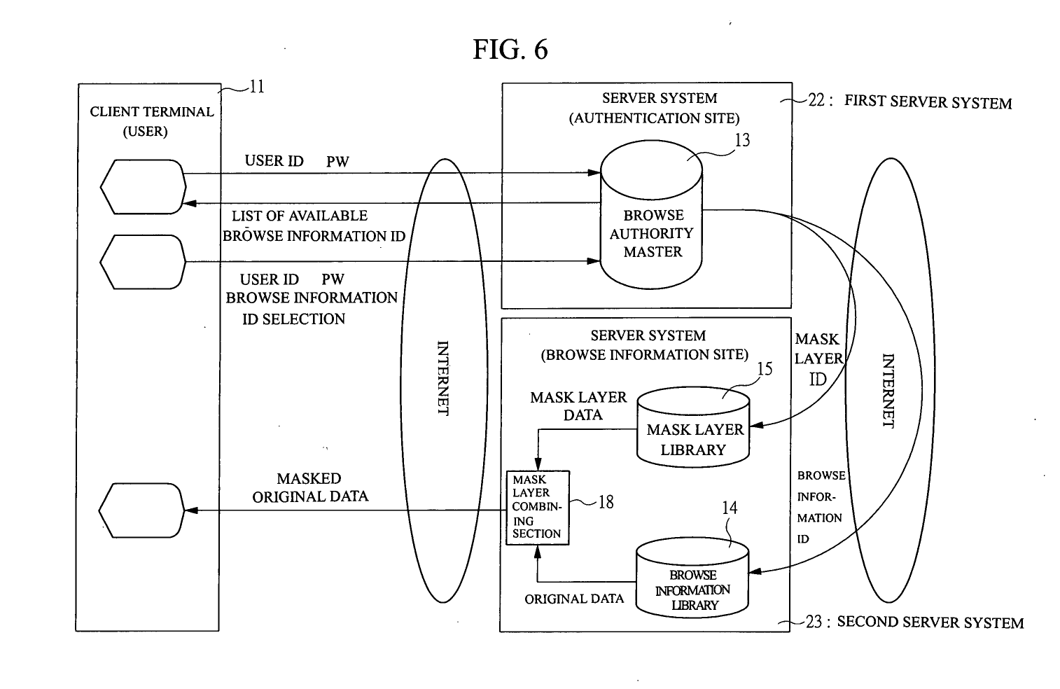

Next, the browse information management system in FIG. 6 is an example where the client terminal 11 is connected to a first server system 22 and a second server system 23 over the Internet and the first server system 22 and the second server system 23 are also connected to each other over the Internet. The first server system 22 has the browse authority master 13, and the second server system 23 has the browse information library 14, the master layer library 15, and the mask layer combining section 18.

The browse information management system in FIG. 6 is characterized in that the browse authority master 13 is independently constructed in the first server system 22. Since the browse authority master 13 is an inlet port of accesses from the outside and contains a large amount of information of the user, it is a database whose security is the most important. Thus, the security can be enhanced by getting the first server system 22 to serve as an authentication site and, at the same time, the system management can be strictly made by using a high-level cryptographic technique also for the communication.

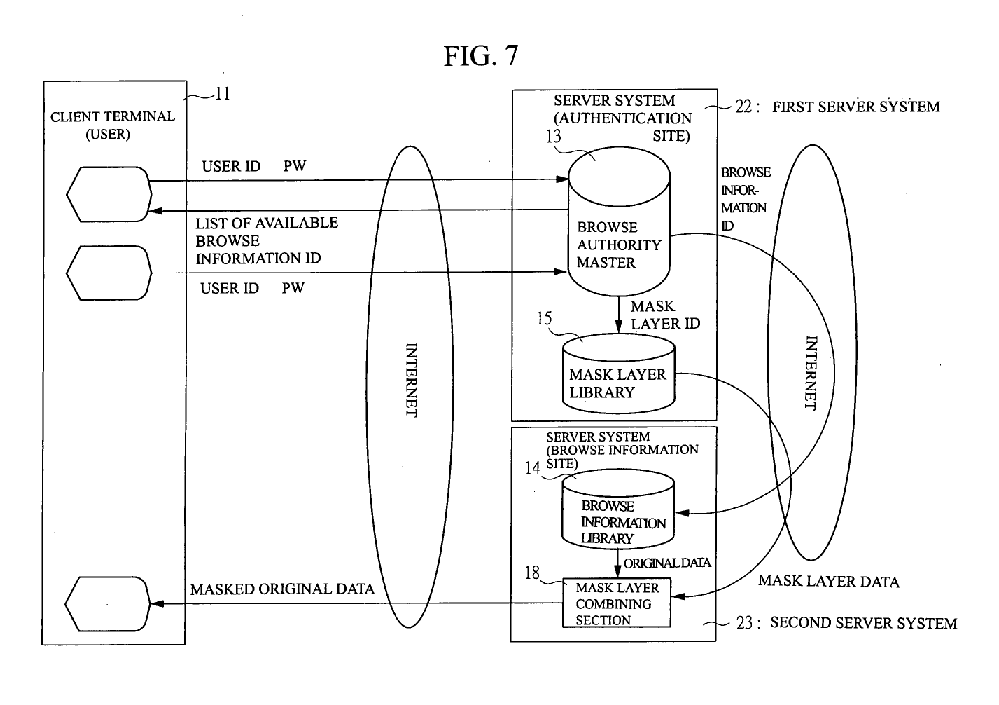

The browse information management system in FIG. 7 is an example in which: the structures of the first server system 22 and the second server system 23 are modified from the browse information management system in FIG. 6; the first server system 22 has the browse authority master 13 and the mask layer library 15; and the second server system 23 has the browse information library 14 and the mask layer combining section 18.

The browse information management system in FIG. 7 is characterized in that a load is equally distributed into the first server system 22 and the second server system 23. As the users, the browse information, and the mask layer data are increased, a large amount of loads are imposed on the servers. If the file capacities also are considered, loads on portions relating to the mask layer library and the browse information library is increased particularly. Therefore, both are separated into different servers so that the loads can be reduced.

Therefore, in addition to effects of the previous embodiment, the browse information management system, which is the modified example of the present embodiment, can get the user to browse, in accordance with the user's browse authority level, data such as electronic document data, image data, and animation data over the Internet, whose partial areas are concealed. Further, it is possible to provide the browse information management system capable of solving problems of the Internet, that is, achieving the enhancement of the security and the reduction of the load on the network server.

Thereby, the browse information management system according to the present invention is useful to distribute, to each person or each group, different information such as newspaper articles or business reports on asset management or the like distributed over the Internet. Further, it can be utilized in the field where information is different for each person or each group and security is also required, for example, in Basic Resident Register Network, a company's homepage disclosing technique information accordingly by an ID or password, or the like.

As described above, the invention made by the present inventors has been concretely described based on the embodiments thereof. However, needless to say, the present invention is not limited to these embodiments and can be variously altered and modified without departing from the gist thereof.

For example, the management system, to which the concealing processing operation technique based on the browse authority level of the basic concept of the present invention is applied, is not limited to the browse information management system in the above-mentioned embodiments, and may be a management system adding, to an application software having original data and a function of overlaying a large number of layers on the original data, a function of controlling a combination of the layers in accordance with the browse authority level.

The effects obtained through representative ones of the inventions disclosed by the present application will be briefly described as follows.

(1) It is possible to provide a browse information management system and a management method capable of flexibly controlling concealment areas, with respect to browse information including documents, images, animations, and the like, in accordance with a user's browse authority level.

(2) It is possible to provide a browse information management system and a management method capable of responding to a large number of users and a large amount of browse information and of controlling concealment areas based on a user's browse authority level.

(3) It is possible to provide a browse information management system and a management method capable of easily achieving maintenance such as responses to a new confidential portion, a new document, a publication date, and a new user, and having no need of processing original browse information when the concealing process of the browse information is performed.

(4) It is possible to construct a browse information management system and a management method optimum for an in-company network as well as the Internet and the like.

What is claimed is:

1. A browse information management system using a computer, the system comprising:
original data which is browse information;
a plurality of pieces of mask layer data in each of which a graphic covering a confidential portion is drawn in accordance with a browse authority level;
a selecting means for selecting a single or plurality of pieces of mask layer data from among said plurality of pieces of mask layer data in accordance with said browse authority level of a user; and
a combining means for combining, with respect to said original data, said single or plurality of pieces of mask layer data selected by said selecting means,
wherein when browse of said browse information is requested from the user, a concealing process is performed to said browse information by said selecting means and said combining means.

2. The browse information management system according to claim 1,
wherein said original data is composed of a plurality of pieces of original data, and
the system further comprises a browse possibility/impossibility determining means for determining a browse possibility/impossibility of each of said plurality of pieces of original data in accordance with said browse authority level of said user, and for getting said user to specify the original data through communication with said user.

3. The browse information management system according to claim 2,
wherein said determining means and said selecting means each have a browse authority master to be referred to, and
said browse authority master has identification information of the user, browse possibility/impossibility information of original data by said user, and mask layer data selecting information of original data browsable by the user.

4. The browse information management system according to claim 3,
wherein said browse authority master has a user authority master and a mask layer master,
said user authority master has a data structure capable of specifying said browse authority level of said user and original data browsable by said user in accordance with identification information of said user, and
said mask layer master has a data structure capable of specifying a single or plurality of pieces of mask layer data to be combined with said original data, in accordance with said browse authority level and said original data specified with reference to said user authority master.

5. The browse information management system according to claim 4, further comprising:
a browse information library; a mask layer library; and a mask layer combining section,
wherein a large amount of original data is stored in said browse information library,
a large amount of mask layer data is stored in said mask layer library,
said browse possibility/impossibility determining means specifies, in response to a browse request from a user, a browse authority level of said user with reference to said user authority master, and specifies original data through communication with said user to extract said specified original data from said browse information library,
said mask layer data selecting means specifies a single or plurality of pieces of mask layer data with reference said the mask layer master, in accordance with said specified original data and said browse authority level, to extract said specified single or plurality of pieces of mask layer data from said mask layer library, and
said mask layer data combining means transmits, to said mask layer combining section, the original data extracted by said determining means and the single or plurality of pieces of mask layer data extracted by said selecting means so as to be combined in said mask layer combining section.

6. A browse information management system comprising a client-server type network system,
wherein a server system has a browse information management system according to any one of claims 1 to 5, and
a client terminal has a browser so that a user makes a browse request of browse information to said server system and acquires browse information through said server system in accordance with a browse authority level of said user.

7. A browse information management system comprising a client-server type network system,
wherein the system has a first server system and a second server system connected to each other via a network,
the browse information management system according to claim 5 is constructed in said first server system and said second server system in a distributed manner,
said first server system has said browse authority master,
said second server system has said mask layer library, said browse information library, and said mask layer combining section, and
when a browse request is transmitted by a user from a client terminal to said first server system, browse information based on a browse authority level of the user is specified through communication between said first server system and said second server system and the specified browse information is returned from said second server system to said client terminal.

8. A browse information management system comprising a client-server type network system,
wherein the system has a first server system and a second server system connected to each other via a network,
the browse information management system according to claim 5 is constructed in said first server system and said second server system in a distributed manner,
said first server system has said browse authority master and said mask layer library,
said second server system has said browse information library and said mask layer combining section, and
when a browse request is transmitted by a user from a client terminal to said first server system, browse information in accordance with a browse authority level of the user is specified through communication between said first server system and said second server system and said specified browse information is returned from said second server system to said client terminal.

9. A browse information management method using a computer, the computer including original data as browse information and a plurality of pieces of mask layer data in each of which a graphic covering a confidential portion is drawn in accordance with a browse authority level, the method comprising the steps of:
when browse of said browse information is requested from a user, selecting a single or plurality of pieces of mask layer data from among said plurality of pieces of mask layer data in accordance with the browse authority level of said user;
combining said selected single or plurality of pieces of mask layer data with respect to said original data; and
outputting said combined data to said user.

10. The browse information management method according to claim 9, further comprising the steps of:
when said single or plurality of pieces of mask layer data are selected, determining a browse possibility/impossibility of said original data by said user with reference to a browse authority master; and
selecting said single or plurality of pieces of mask layer data in accordance with the browsable original data.
